(19) United States
(12) Patent Application Publication
(10) Pub. No.: US 2012/0302668 A1
(43) Pub. Date: Nov. 29, 2012

(54) SEMICONDUCTOR SEALING MATERIAL COMPOSITION

(75) Inventors: Suk-Hong CHOI, Seoul (KR); Sang-Hee PARK, Bucheon-si (KR)

(73) Assignee: G&CS CO., LTD., Seoul (KR)

(21) Appl. No.: 13/481,321

(22) Filed: May 25, 2012

(30) Foreign Application Priority Data
May 27, 2011 (KR) 10-2011-0050522

(51) Int. Cl. C09D 163/00; C08K 3/24; C09D 163/04; C09D 163/02; B82Y 30/00

(52) U.S. Cl. 523/458; 523/468; 977/773

(57) ABSTRACT

Disclosed herein is a semiconductor sealing material composition, including: 9.0˜13 wt % of an epoxy resin; 6˜7 wt % of a hardener; 0.2˜0.3 wt % of a curing catalyst; 0.60˜0.68 wt % of at least one additive selected from the group consisting of a coupling agent, a release agent and a coloring agent; and 79˜84 wt % of a filler, wherein the filler is nano-graphene plate powder. The semiconductor sealing material composition has excellent crack resistance at a high temperature of 270° C. or more and has high thermal conductivity and excellent flame retardancy.

### BACKGROUND OF THE INVENTION

1. Technical Field

The present invention relates to a semiconductor sealing material composition, and, more particularly, to a semiconductor sealing material composition including nano-graphene plate powder.

2. Description of the Related Art

An epoxy molding compound (EMC), which is used as a semiconductor sealing material, is generally used as a packaging material used to protect electronic parts, such as integrated circuits (ICs), large-scale integrated circuits (LSIs), transistors, diodes and the like, or semiconductor devices from externally-applied shocks, vibrations, moisture, radiations and the like. The semiconductor sealing material includes: an organic material for forming a three-dimensional structure using thermal hardening, such as an epoxy resin and a hardener; an inorganic material for improving thermal, electrical and mechanical properties thereof, such as a silica filler; and other additives, such as a catalyst for controlling a hardening rate, a coupling agent for improving the bonding force between organic and inorganic materials, a release agent for providing releasability during molding work, a coloring agent, a flame-retardant, etc. Here, the reason why silica is used as a filler is because it has high mechanical durability and electrical stability. However, a conventional semiconductor sealing material is problematic in that, when a semiconductor is mounted on a printed circuit board (PCB), water included therein is exposed to a high temperature of 200° C. or more to be vaporized to generate water vapor, so that the semiconductor sealing material is cracked by pressure of the water vapor.

In order to solve the above problem, a method of increasing the filling rate of silica particles by changing the composition ratio of a conventional semiconductor sealing material or adjusting the content of a curing catalyst has been proposed. For example, Korea Unexamined Patent Publication No. 2003-0056507 disclosed a method of improving the crack resistance of a semiconductor sealing material at a high temperature by adding a small amount of nanosized silica particles as well as microsized silica particles. However, this method was not a basic solution.

As alloys are now used instead of lead due to its environmental impact, a semiconductor sealing material having excellent crack resistance at a high temperature of 270° C. or more is required. Further, as semiconductor chips are highly functionalized and highly integrated, heat is generated therefrom, and thus the performance and lifecycle of a semiconductor is deteriorated, so that a semiconductor sealing material that can rapidly discharge heat to the outside of a semiconductor is required.

Therefore, as described above, it is required to develop an environment-friendly semiconductor sealing material which has excellent crack resistance and high thermal conductivity, which satisfies environmental impact assessment factors such as RoHS (Restriction of Hazardous Substances) and the like, which does not include a halogen element, and which has flame retardancy.

### SUMMARY OF THE INVENTION

Accordingly, the present invention has been devised to solve the above-mentioned problems, and an object of the present invention is to provide a semiconductor sealing material composition which has excellent crack resistance at a high temperature and which has high thermal conductivity and excellent flame retardancy.

In order to accomplish the above object, an aspect of the present invention provides a semiconductor sealing material composition, including: 9.0˜13 wt % of an epoxy resin; 6˜7 wt % of a hardener; 0.2˜0.3 wt % of a curing catalyst; 0.60˜0.68 wt % of at least one additive selected from the group consisting of a coupling agent, a release agent and a coloring agent; and 79˜84 wt % of a filler.

Here, the filler may be nano-graphene plate powder. The nano-graphene plate powder may be prepared by the steps of: treating natural graphite with at least one selected from a combination of sulfuric acid and hydrogen peroxide (H₂O₂) a combination of sulfuric acid and potassium permanganate (KMnO₄) and a combination of sulfuric acid and nitric acid to form an interlayer graphite compound, and then instantaneously expanding the interlayer graphite compound in a high-temperature furnace; and introducing the expanded graphite into an aqueous solution and then interlayer-peeling the expanded graphite using ultrasonic waves.

The nano-graphene plate powder may be prepared by SiC pyrolysis or chemical vapor deposition.

The nano-graphene plate powder may have a particle size of 5˜40 μm and/or a thickness of 1˜100 nm.

The nano-graphene plate powder may have a thermal conductivity of 400 W/mK or more.

The semiconductor sealing material composition may have a thermal conductivity of 2.0˜5.5 W/mK.

The semiconductor sealing material composition may have a toughness of 200˜2700 J/m².

The epoxy resin may be at least one selected from the group consisting of a biphenyl epoxy resin, a novolac epoxy resin, a dicyclopentadienyl epoxy resin, a bisphenol epoxy resin, a terpene epoxy resin, an aralkyl epoxy resin, a multi-functional epoxy resin, a naphthalene epoxy resin and a halogenated epoxy resin.

The hardener may be at least one selected from the group consisting of a phenolic novolac resin, a cresol novolac resin, a multi-functional phenolic resin, an aralkyl phenolic resin, a terpene phenolic resin, a dicyclopentadienyl phenolic resin, a naphthalene phenolic resin and a halogenated phenolic resin.

The coupling agent may be at least one selected from the group consisting of vinyltriethoxysilane, 1,3-glycidoxypropyltrimethoxysilane, 1,3-aminopropylethoxysilane, and 1,3-mercaptopropyltrimethoxysilane.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an electron microscope photograph of the nano-graphene plate according to the present invention, which is magnified 5,000 times; and

FIG. 2 is an electron microscope photograph of the nano-graphene plate according to the present invention, which is magnified 50,000 times.

### DESCRIPTION OF THE PREFERRED EMBODIMENTS

Hereinafter, preferred embodiments of the present invention will be described in detail with reference to the attached drawings.

These embodiments are set forth to illustrate the present invention, and the scope of the present invention is not limited thereto.

Graphite, which is a main component of nano-graphene plate, is formed when one 2S orbital and two 2P orbitals of a carbon atom are bonded to form three SP² hybrid orbitals. In these SP² hybrid orbitals, one n-electron exists per carbon atom, and thus graphite has thermal conductivity and anisotropy. It is known that graphite has a thermal conductivity of about 250 W/mK or more in a horizontal direction (a-b axis), and has a thermal conductivity of about 5 W/mK or less in a vertical direction (c axis). The thermal conductivity of graphite is high when the porosity thereof is low, that is, the density thereof is high. For example, when the density of graphite is 1.8 g/ml, the thermal conductivity thereof is 250 W/mK or more.

Meanwhile, nano-graphene plate powder, compared to graphite, has excellent thermal conductivity, electrical conductivity, high-temperature resistance and corrosion resistance, has a low friction coefficient, and has a good self-lubricating property. Further, nano-graphene plate powder is characterized in that it absorb neutrons, it endures even when it is irradiated with beta rays and gamma rays for a long period of time, it can be easily compressed because it is flexible, and it does not allow liquid or gas to permeate therein.

The nano-graphene plate powder, which is used as a filler in an embodiment of the present invention, is prepared as follows.

First, natural graphite is treated with at least one selected from a combination of sulfuric acid and hydrogen peroxide (H₂O₂), a combination of sulfuric acid and potassium permanganate (KMnO₄) and a combination of sulfuric acid and nitric acid to form an interlayer graphite compound, and then the interlayer graphite compound is instantaneously expanded in a high-temperature furnace.

Subsequently, the expanded graphite is introduced into an aqueous solution, is interlayer-peeled using ultrasonic waves, and is then pulverized to form a nano-graphene plate.

Meanwhile, as the thickness of a nano-graphene plate is decreased, Van der Waals force, which is molecular attraction between graphene layers, becomes weak, and thus the characteristics of the nano-graphene plate become approximate to the intrinsic characteristics of graphene. Therefore, when the nano-graphene plate is bonded with an epoxy resin, Van der Waals force becomes weak, thus improving the bonding strength of a semiconductor sealing material.

Subsequently, the aqueous solution including the nano-graphene plate is filtered and dried to obtain nano-graphene plate powder.

In this case, the obtained nano-graphene plate powder has physical properties of an apparent specific volume of 250 ml/g or more, a thickness of 1˜100 nm, a particle size of 5˜40 μm and a thermal conductivity of 400 W/mK or more.

Meanwhile, the nano-graphene plate powder may be prepared by SiC pyrolysis or chemical vapor deposition (CVD) using methane gas.

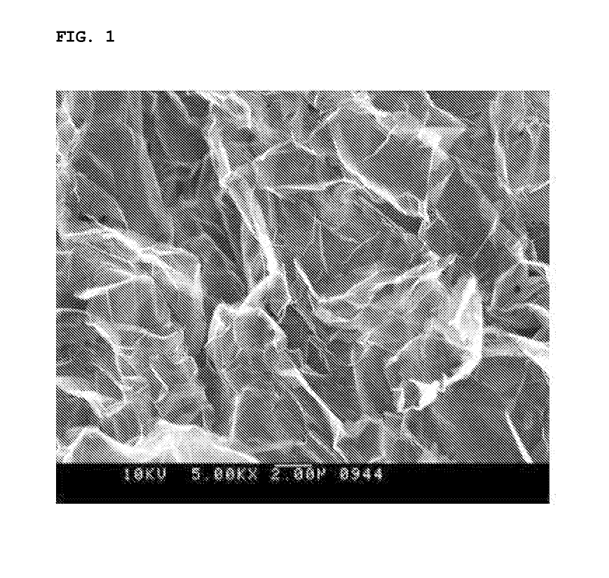

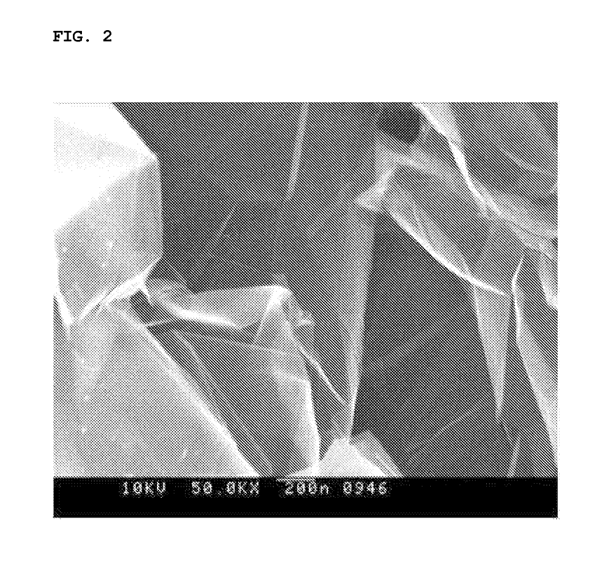

FIGS. 1 and 2 are electron microscope photographs of the nano-graphene plate powder according to an embodiment of the present invention, which are magnified 5,000 times and 50,000 times, respectively. As shown in FIGS. 1 and 2, it can be ascertained that graphite powder is formed into graphene powder because the shape of particles is present in the form of wrinkles, not plates.

As the epoxy resin, hardener, curing catalyst and coupling agent used in an embodiment of the present invention, all commercially available materials may be used as long as they are used to manufacture general sealing materials by those skilled in the art.

The method of manufacturing a semiconductor sealing material according to an embodiment of the present invention will be described as follows.

The nano-graphene plate is pulverized into nano-graphene plate powder having an apparent specific volume of 250 ml/g, a thickness of 1˜100 nm and a particle size of 5˜40 μm. The nano-graphene plate powder is mixed with an epoxy resin, a hardener, a curing catalyst and other additives and then further pulverized. The powder is melted, quenched to room temperature, pulverized and extruded using a two-roll mill to manufacture a semiconductor sealing material composition.

The component ratios of the semiconductor sealing material composition including an epoxy resin, a hardener, a curing catalyst, a coupling agent and nano-graphene plate powder (a filler) having a particle size of 5˜40 μm according to examples of the present invention are given in Table 1 below.

Concretely, the epoxy resin is at least one selected from the group consisting of a biphenyl epoxy resin, a novolac epoxy resin, a dicyclopentadienyl epoxy resin, a bisphenol epoxy resin, a terpene epoxy resin, an aralkyl epoxy resin, a multi-functional epoxy resin, a naphthalene epoxy resin and a halogenated epoxy resin. The amount of the epoxy resin is 9˜13 wt %.

The hardener, which is a conventional hardener used in an epoxy resin, is at least one selected from the group consisting of a phenolic novolac resin, a cresol novolac resin, a multi-functional phenolic resin, an aralkyl phenolic resin, a terpene phenolic resin, a dicyclopentadienyl phenolic resin, a naphthalene phenolic resin and a halogenated phenolic resin. The amount of the hardener is 6˜7 wt %.

The curing catalyst, which is a conventional catalyst, includes phosphines such as triphenyl phosphine and the like, amines, etc. The amount of the curing catalyst is 0.2˜0.3 wt %.

The semiconductor sealing material composition according to an embodiment of the present invention may include at least one additive selected from the group consisting of a coupling agent, a release agent and a coloring agent.

The coupling agent is at least one selected from the group consisting of vinyltriethoxysilane, 1,3-glycidoxypropyltrimethoxysilane, 1,3-aminopropylethoxysilane, and 1,3-mercaptopropyltrimethoxysilane.

The release agent or the coloring agent is at least one selected from the group consisting of wax and carbon black.

The amount of the additive is 0.6˜0.7 wt %.

Further, the semiconductor sealing material composition according to an embodiment of the present invention may not include a release agent because it has a self-lubricating property, and may not include a flame retardant because it has flame retardancy.

The powder is melted, quenched to room temperature, pulverized and extruded using a two-roll mill to manufacture a sealing material composition.

The toughness and thermal conductivity of the semiconductor sealing material composition according to examples of the present invention were measured, and the results thereof are given in Table 2 and Table 3, respectively.

TABLE 1
(unit: wt %)

| Components | Comp. Exp. 1 | Exp. 1 | Exp. 2 | Exp. 3 |
|---|---|---|---|---|
| Epoxy resin | 12.5 | 12.5 | 10.5 | 9.0 |
| Hardener | 6.87 | 6.87 | 6.90 | 6.85 |
| Curing catalyst | 0.25 | 0.25 | 0.20 | 0.20 |
| Coupling agent | 0.68 | 0.68 | 0.68 | 0.60 |
| Nano-graphene plate | — | 79.7 | 81.72 | 83.35 |
| powder (filler) | | | | |
| Spherical silica | 79.7 | — | — | — |
| (filler) | | | | |

TABLE 2

| | Room temperature | High temperature |
|---|---|---|
| Toughness (J/m²) | (25° C.) | (270° C.) |
| Exp. 1 | 2000 | 220 |
| Exp. 2 | 2100 | 260 |
| Exp. 3 | 2700 | 300 |
| Comp. Exp. 1 | 875 | 25 |

TABLE 3

| | Thermal conductivity (W/mK) |
|---|---|
| Exp. 1 | 2.2 |
| Exp. 2 | 3.1 |
| Exp. 3 | 5.3 |
| Comp. Exp. 1 | 0.5 |

The toughness measurement of Table 2 was carried out according to ASTM-E399, and the thermal conductivity measurement was carried out by the laser flash (LFA) method based on ASTM-E1461. As given in Table 2 above, it can be seen that the toughness of the semiconductor sealing material composition of each of Examples 1 to 3 was higher than that of the semiconductor sealing material composition of Comparative Example 1 by three times or more at room temperature and ten times or more at a high temperature, and thus the crack resistance of the semiconductor sealing material composition of each of Examples 1 to 3 was greatly improved compared to that of the semiconductor sealing material composition of Comparative Example 1.

The reason for this is that the nano-graphene plate of the semiconductor sealing material composition of each of Examples 1 to 3 is hydrophobic, the amount of moisture included in the semiconductor sealing material composition is extremely small, and bubbles easily pass between nano-graphene plate layers and between particles.

Further, as given in Table 3 above, it can be seen that the thermal conductivity of the semiconductor sealing material composition of each of Examples 1 to 3 was improved by 4˜10 times compared to that of Comparative Example 1.

The reason for this is that the thermal conductivity of silica, which is a main component of the semiconductor sealing material composition of Comparative Example 1, is 1.38 W/mK or less, by which the heat generated at the time of operating a semiconductor cannot be effectively transferred to the outside, whereas the thermal conductivity of the nano-graphene plate of the semiconductor sealing material composition of each of Examples 1 to 3 is 400 W/mK, by which the heat generated at the time of operating a semiconductor can be effectively transferred to the outside, so that the nano-graphene plate is excellent compared to the silica in terms of thermal conductivity.

Therefore, as given in Table 2 and Table 3, it can be ascertained that, since the semiconductor sealing material composition of each of Examples 1 to 3 has high thermal conductivity and excellent crack resistance, a large amount of heat generated from the inside of a semiconductor chip is rapidly transferred to the outside thereof, and thus the semiconductor chip is rapidly cooled.

As described above, the semiconductor sealing material composition according to the present invention is advantageous in that the crack resistance thereof at a high temperature, which is a problem of a conventional semiconductor sealing material, can be greatly improved because nano-graphene plate powder obtained by pulverizing a nano-graphene plate having an apparent specific volume of 250 ml/g or more and a thickness of 1˜100 nm to a particle size of 5˜40 μm is used, and in that it has high thermal conductivity and easily absorbs neutrons, so radioactive rays (α, β, γ rays) are not discharged to the outside, thereby solving the problem of abnormal semiconductor operation caused by external influences.

Further, the semiconductor sealing material composition according to the present invention is advantageous in that, since the nano-graphene plate used in the present invention satisfies environmental impact assessment factors such as RoHS (Restriction of Hazardous Substances), has acquired a UL94-VO certification (halogen-free flame retardance test) and does not need a release agent and a coloring agent, the semiconductor sealing material composition can be manufactured by a simple process, and the durability thereof can be improved, and in that, since the nano-graphene plate has high thermal conductivity, power consumption is reduced by the synergetic effect of the operation speed of a semiconductor chip, and thus this semiconductor sealing material composition coincides with low energy policies and environment-friendly low-carbon green growth policies.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A semiconductor sealing material composition, comprising:
9.0˜13 wt % of an epoxy resin;
6˜7 wt % of a hardener;
0.2˜0.3 wt % of a curing catalyst;
0.60˜0.68 wt % of at least one additive selected from the group consisting of a coupling agent, a release agent and a coloring agent; and
79˜84 wt % of a filler,
wherein the filler is nano-graphene plate powder.

2. The semiconductor sealing material composition according to claim 1, wherein the nano-graphene plate powder has a particle size of 5˜40 μm.

3. The semiconductor sealing material composition according to claim 2, wherein the nano-graphene plate powder has a thickness of 1˜100 nm.

4. The semiconductor sealing material composition according to claim 1, wherein the nano-graphene plate powder has a thermal conductivity of 400 W/mK or more.

5. The semiconductor sealing material composition according to claim 1, wherein the composition has a thermal conductivity of 2.0˜5.5 W/mK.

6. The semiconductor sealing material composition according to claim 1, wherein the composition has a toughness of 200˜2,700 J/m².

7. The semiconductor sealing material composition according to claim 1, wherein the epoxy resin is at least one selected from the group consisting of a biphenyl epoxy resin, a novolac epoxy resin, a dicyclopentadienyl epoxy resin, a bisphenol epoxy resin, a terpene epoxy resin, an aralkyl epoxy resin, a multi-functional epoxy resin, a naphthalene epoxy resin and a halogenated epoxy resin, and the hardener is at least one selected from the group consisting of a phenolic novolac resin, a cresol novolac resin, a multi-functional phenolic resin, an aralkyl phenolic resin, a terpene phenolic resin, a dicyclopentadienyl phenolic resin, a naphthalene phenolic resin and a halogenated phenolic resin.

8. The semiconductor sealing material composition according to claim 1, wherein the coupling agent is at least one selected from the group consisting of vinyltriethoxysilane, 1,3-glycidoxypropyltrimethoxysilane, 1,3-aminopropylethoxysilane, and 1,3-mercaptopropyltrimethoxysilane.

9. The semiconductor sealing material composition according to claim 1, wherein the nano-graphene plate powder is prepared by the steps of: treating natural graphite with at least one selected from a combination of sulfuric acid and hydrogen peroxide (H₂O₂), a combination of sulfuric acid and potassium permanganate (KMnO₄) and a combination of sulfuric acid and nitric acid to form an interlayer graphite compound, and then instantaneously expanding the interlayer graphite compound in a high-temperature furnace; and introducing the expanded graphite into an aqueous solution and then interlayer-peeling the expanded graphite using ultrasonic waves.

10. The semiconductor sealing material composition according to claim 1, wherein the nano-graphene plate powder is prepared by SiC pyrolysis or chemical vapor deposition.
